(19) United States
(12) Patent Application Publication
(10) Pub. No.: US 2009/0093394 A1
(43) Pub. Date: Apr. 9, 2009

(54) Fabric Conditioning Compositions

(76) Inventors: Randal Bernhardt, Antioch, IL (US); Stephane Courdavault-Duprat, Moirans (FR); David Stephen Grainger, Wirral (GB); John Francis Hubbard, Wirral (GB); Matthew Levinson, Lincolnwood, IL (US); Marshall Nepras, Burlington, WI (US); Didier Ray, Saint Egreve (FR); Michael Terry, Gurnee, IL (US)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/223,726

(22) PCT Filed: Jan. 31, 2007
(86) PCT No.: PCT/EP2007/000898

§ 371 Date: Nov. 13, 2008

(30) Foreign Application Priority Data
Feb. 10, 2006 (GB) 0602741.1

(51) Int. Cl. C11D 1/62; C11D 3/00

(52) U.S. Cl. 510/515

(57) ABSTRACT

A fabric softening composition comprising from 1 to 80% by weight of ester-linked quaternary ammonium fabric softening material comprising a quaternised mixture of mono- di- and tri-ester of alkanolamine in which the tri-ester content of said mixture is from 25 to 50% by weight of said mixture, wherein: (i) when the tri-ester content is from 25 to 30% by weight of said mixture the free amine content of the composition is less than 0.5% by weight on the weight of said mixture, (ii) when the tri-ester content is more than 30% by weight of said mixture the free amine content of the composition is less than 6% by weight based on the weight of said mixture, the composition containing less than 1% by weight of free fatty acid based on said mixture.

### FIELD OF THE INVENTION

The present invention relates to fabric conditioning compositions. More specifically, the invention relates to fabric softening compositions comprising ester-linked quaternary ammonium compounds that exhibit good rheological stability.

### BACKGROUND OF THE INVENTION

Liquid fabric conditioning compositions which soften fabrics in the rinse cycle are known.

Such compositions comprise less than 7.5% by weight of softening active, in which case the composition is defined as “dilute”, from 7.5% to about 30% by weight of active in which case the compositions are defined as “concentrated” or more than about 30% by weight of active, in which case the composition is defined as “super-concentrated”.

Concentrated and super-concentrated compositions are desirable since these require less packaging and are therefore environmentally more compatible than dilute or semi-dilute compositions.

A problem frequently associated with fabric conditioning compositions, as defined above, is that the product is not stable upon storage, especially when stored at high temperatures. Instability can manifest itself as a thickening of the product upon storage, even to the point that the product is no longer pourable.

The problem of thickening upon storage is particularly apparent in concentrated and super concentrated fabric softening compositions comprising an ester-linked quaternary ammonium fabric softening material having one or more fully saturated alkyl chains.

However, it is desirable to use ester-linked compounds due to their inherent biodegradability and to use substantially fully saturated quaternary ammonium fabric softening compounds due to their excellent softening capabilities and because they are more stable to oxidative degradation (which can lead to malodour generation) than partially saturated or fully unsaturated quaternary ammonium softening compounds.

Of the types of ester-linked quaternary ammonium materials known, it is desirable to use those based on triethanolamine which comprise at least some mono-ester linked component and at least some tri-ester linked component.

A further problem known to affect concentrated and super-concentrated fabric softening compositions is that the initial viscosity of a fully formulated composition can be very high, up to a point that the composition is substantially unpourable.

The problem of undesirably high initial viscosity and visco-stability upon storage has previously been addressed in various ways.

For instance, EP-A2-0415698 (Unilever) discloses the use of electrolytes, polyelectrolytes, or decoupling polymers to reduce the initial viscosity of fabric softening compositions.

It is also known that an input of energy such as milling or shearing of the product can reduce product viscosity. However, compositions produced by both of these approaches can suffer from colloidal instability. Also, milling or shearing products in a manufacturing process on an industrial scale is time consuming and expensive.

DE 2503026 (Hoechst) discloses formulations comprising 3-12% of a softener (a mixture of non-ester quaternary ammonium compounds imidazoline group containing compounds), 1-6% of a cationic disinfectant, 0.1-5% of a lower alcohol, 0.5-5% of a fatty alcohol and 0-5% of a non-ionic emulsifier.

WO 99/50378 (Unilever) relates to compositions comprising from 1 to 8% of a quaternary ammonium compound, a stabilising agent and a fatty alcohol. The fatty alcohol is present in order to thicken the dilute composition.

WO03/022970 discloses a fabric conditioning composition comprising:
(a) from 7.5 to 80% by weight of an ester-linked quaternary ammonium fabric softening material comprising at least one mono-ester component and at least one tri-ester component;
(b) from 0.01 to 10% by weight of a non-ionic surfactant; and
(c) greater than 1.5% to 15% by weight of a fatty complexing agent;
   wherein the weight ratio of the mono-ester component of compound (a) to compound (c) is from 5:1 to 1:5.

It is stated it has surprisingly been found that by incorporating a fatty component which comprises a long alkyl chain, such as fatty alcohols or fatty acids (hereinafter referred to as “fatty complexing agents”) together with a non-ionic surfactant into softening compositions comprising a quaternary ammonium softening material having substantially fully saturated alkyl chains, at least some mono-ester linked component and at least some tri-ester linked component, where the fatty complexing agent is present in an amount significantly greater than normally present in traditional fabric softening compositions, then the stability and initial viscosity of the composition can be dramatically improved. In particular, undesirable thickening of the composition upon storage can be avoided.

The reference discloses that typical components in the ESTERQUAT material include mono-ester 10-30%, di-ester 20-60%, tri-ester 10-30%, free fatty acid 0.2-1.0%. There is no disclosure of the free amine content.

Similar disclosures are found in WO03/022969, WO03/022971, WO03/022972, WO03/022697 and EP1323818.

Other patents have addressed the distribution of the ester components in the quaternary ammonium softening agent.

U.S. Pat. No. 6,323,167 discloses a textile softening composition which comprises, as a softening agent, a quaternary ammonium salt which comprises a mixture of mono-, di- and tri-ester components wherein the amount of a di-ester quaternary is greater than 55% by weight and the amount of tri-ester quaternary is less than 20% by weight based the total amount of quaternary ammonium salt. There is no disclosure of the free amine content.

WO93/23510 discloses concentrated fabric softening compositions in which the di-ester component is at least 80% and the mono-ester component is up to 20%. It is stated for softening, the percentage of di-ester should be as high as possible, preferably more than 90%.

WO91/01295 discloses quaternary ammonium compounds with amino-ester function which are used as textile softeners. The compounds disclosed have different ester distributions, the mono-ester content ranging from 10 to 24%, the di-ester content ranging from 40 to 62% and the tri-ester content ranging from 26 to 43%.

Generally, the esterquats are prepared by reaction of a fatty acid with a trialkanolamine, e.g. triethanolamine, and then quaternised e.g. with di-methyl sulphate. The ratio of fatty acid to triethanolamine affects the distribution of the resulting mono-, di- and tri-esters. However, the quaternisation stage also affects the distribution because a proportion of the tri-ester amine is not quarternised due to steric hindrance and remains as a free amine.

WO93/25648 discloses fabric softening compositions comprising quaternary ammonium salts containing at least 1 reverse ester linkage. The compositions are substantially free of amines, since free amines can catalyse decomposition of the quarternised ester-amine softening compounds on storage.

It has now been found that the visco stability of a fabric composition can be controlled by a particular selection of the ester distribution and by maintaining low levels of ester amine and free fatty acid.

### SUMMARY OF THE INVENTION

According to the present invention there is provided a fabric softening composition comprising from 1 to 80% by weight of ester-linked quaternary ammonium fabric softening material comprising a quaternised mixture of mono- di- and tri-ester of alkanolamine in which the tri-ester content of said mixture is from 25 to 50% by weight of said mixture, wherein:
(i) when the tri-ester content is from 25 to 30% by weight of said mixture the free amine content of the composition is less than 0.5% by weight on the weight of said mixture,
(ii) when the tri-ester content is more than 30% by weight of said mixture the free amine content of the composition is less than 6% by weight based on the weight of said mixture,
   the composition containing less than 1% by weight of free fatty acid based on said mixture.

### DETAILED DESCRIPTION OF THE INVENTION

The compositions of the present invention are preferably rinse conditioner compositions, more preferably aqueous rinse conditioner compositions for use in the rinse cycle of a domestic laundry process.

### Quaternary Ammonium Fabric Softening Material

The fabric conditioning material used in the compositions of the present invention comprises quaternary ammonium materials comprising a mixture of mono-ester di-ester and tri-ester components wherein the tri-ester component is from 25 to 50% by weight of the mixture.

By mono-, di- and tri-ester linked components, it is meant that the quaternary ammonium softening material comprises, respectively, a quaternary ammonium compound comprising a single ester-link with a fatty hydrocarbyl chain attached thereto, a quaternary ammonium compound comprising two ester-links each of which has a fatty hydrocarbyl chain attached thereto, and a quaternary ammonium compound comprising three ester-links each of which has a fatty hydrocarbyl chain attached thereto.

Preferably, the average chain length of the alkyl or alkenyl group is at least C₁₄, more preferably at least C₁₆.

It is generally preferred if the alkyl or alkenyl chains are predominantly linear.

The preferred ester-linked quaternary ammonium cationic softening material for use in the invention is represented by formula (I):

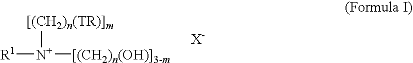

wherein each R is independently selected from a C₅₋₃₅ alkyl or alkenyl group, R¹ represents a C₁₋₄ alkyl or hydroxyalkyl group or a C₂₋₄ alkenyl group,

T is

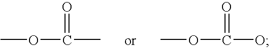

n is O or an integer selected from 1 to 4, m is 1, 2 or 3 and denotes the number of moieties to which it refers that pend directly from the N atom, and X⁻ is an anionic group, such as halides or alkyl sulphates, e.g. chloride, methyl sulphate or ethyl sulphate.

Especially preferred materials within this class are esters of triethanol ammonium methyl sulphate, particularly tallow or hardened tallow esters.

The tri-esterquat content of the fabric conditioning material is from 25 to 50% by weight. This tri-esterquat content can be provided in a variety of ways, as by using a relatively high ratio of the fatty acid to the starting alkanolamine in the reaction mixture, using an optimal amount of a suitable catalyst in the reaction mixture for promoting triester formation, raising the temperature of the reaction mixture relatively slowly, and other expedients known to the skilled person.

The contemplated di-esterquat content of the esterquat mixture is at most 70%, optionally at most 60%, optionally at most 50%, optionally at most 40% optionally at most 30% by weight of the esterquat mixture. The contemplated di-esterquat content of the esterquat mixture is at least 30%, optionally at least 40%, optionally at least 50%, optionally at most 55%, optionally at least 60%, optionally at least 65% by weight of the esterquat mixture.

The weight percentages of the mono-, di-, and tri-esterquats in the esterquat mixture are reported on the basis of the total weight of the three. Thus, the sum of these three percentages is 100%. The weight percentages of free amine and fatty acid in the esterquat mixture are also stated here based on the total weight of mono-, di-, and tri-esterquats in the esterquat mixture. In practice it has been found that higher tri-ester contents can tolerate more free amine content in the composition without deleteriously affecting visco stability. When the tri-ester content is from 25 to 30% by weight the free amine content of the composition should be as low as possible and below 0.5% by weight. When the tri-ester content is greater than 30% by weight additional free amine may be tolerated in the composition providing it does not amount to more than 6% by weight of the mixture.

The free (i.e. unquaternized) amine content may be adjusted by controlling the reaction conditions of the preparation of the esterquats, for example, (1) by charging a suitable amount of quaternising agent close to a 1:1 molar ratio of amines to quaternizing agent, (2) by carrying out the reaction long enough to consume the desired percentage of free amine present at the beginning of the quaternisation reaction, or (3) by selecting a suitable quaternising agent (for example, dimethyl sulphate is contemplated). Alternatively and/or in addition, an acid may be added toward the end of the preparation of the esterquats and/or during the preparation of the fabric conditioning composition to reduce the free amine content.

The compositions should contain less than 1% by weight of free fatty acid based on the fabric conditioning material. A low free fatty acid content can be provided, for example, by reacting a fatty acid or a parent fatty acyl compound (such as a glyceride, alkyl ester, or acid chloride) and trialkanolamine under conditions, such as a low enough ratio of fatty acid to trialkanolamine and a long enough reaction time at elevated temperature, effective to consume at least 99% of the initial charge of fatty acid or parent.

References to percentage by weight of the mixture refer to amounts based on the weight of the raw fabric softening material which comprises a mixture of the esters and minor amounts of associated compounds.

### Iodine Value of the Parent Fatty Acyl Group or Acid

The iodine value of the parent fatty acyl compound or acid from which the quaternary ammonium fabric softening material is formed is from 0 to 20, preferably from 0 to 5, more preferably from 0 to 2. Most preferably the iodine value of the parent fatty acid or acyl group from which the quaternary ammonium fabric softening material is formed is from 0 to 1. That is, it is preferred that the alkyl or alkenyl chains are substantially fully saturated.

If there is any unsaturated quaternary ammonium fabric softening material present in the composition, the iodine value, referred to above, represents the mean iodine value of the parent fatty acyl compounds or fatty acids of all of the quaternary ammonium materials present.

In the context of the present invention, iodine value of the parent fatty acyl compound or acid from which the fabric softening material formed, is defined as the number of grams of iodine which react with 100 grams of the compound.

In the context of the present invention, the method for calculating the iodine value of a parent fatty acyl compound/acid comprises dissolving a prescribed amount (from 0.1-3 g) into about 15 ml chloroform. The dissolved parent fatty acyl compound/fatty acid is then reacted with 25 ml of iodine monochloride in acetic acid solution (0.1M). To this, 20 ml of 10% potassium iodide solution and about 150 ml deionised water is added. After addition of the halogen has taken place, the excess of iodine monochloride is determined by titration with sodium thiosulphate solution (0.1M) in the presence of a blue starch indicator powder. At the same time a blank is determined with the same quantity of reagents and under the same conditions. The difference between the volume of sodium thiosulphate used in the blank and that used in the reaction with the parent fatty acyl compound or fatty acid enables the iodine value to be calculated.

The quaternary ammonium fabric softening material of formula (I) is present in an amount from 1 to 80% by weight of quaternary ammonium material (active ingredient) based on the total weight of the composition, generally 2 to 60% by weight, e.g. 5 to 25% by weight.

Broadly speaking, the conditioning active compositions of the present invention, also known as esterquats, are made by combining a fatty acid source and an alkanolamine, typically at a starting temperature at which the fatty acid source is molten, optionally adding a catalyst, then heating the reaction mixture while drawing vacuum until the desired endpoint(s), such as acid value and final alkalinity value, are reached. The resulting esteramine intermediate is then quaternised using an alkylating agent, yielding an esterquat product. The esterquat product is a mixture of quaternised monoester, diester, and triester components and optionally some amount of one or more reactants, intermediates, and byproducts, including but not limited to free amine and free fatty acid or parent fatty acyl compounds.

### Fatty Complexing Agent

The compositions of the present invention comprise a fatty complexing agent. Especially suitable fatty complexing agents include fatty alcohols.

Preferred fatty alcohols include hardened C₁₆-C₁₈ fatty alcohol (available under the tradenames Stenol and Hydrenol, ex Cognis and Laurex CS, ex Albright and Wilson) and behenyl alcohol, a C22 chain alcohol, available as Lanette 22 (ex Henkel).

The fatty complexing agent is present in an amount greater than 0.2% to 15% by weight based on the total weight of the composition. More preferably, the fatty component is present in an amount of from 0.25 to 5%, most preferably from 0.3 to 1% by weight.

### Nonionic Surfactant

Although it is not preferred, the compositions may optionally further comprise a non-ionic surfactant. Typically these can be included for the purpose of stabilising the compositions.

Suitable non-ionic surfactants include addition products of ethylene oxide and/or propylene oxide with fatty alcohols.

Any of the alkoxylated materials of the particular type described hereinafter can be used as the non-ionic surfactant.

Suitable surfactants are substantially water soluble surfactants of the general formula:

R—Y—(C₂H₄O)_{z}—C₂H₄OH

where R is selected from the group consisting of primary, secondary and branched chain alkyl and/or acyl hydrocarbyl groups; primary, secondary and branched chain alkenyl hydrocarbyl groups; and primary, secondary and branched chain alkenyl-substituted phenolic hydrocarbyl groups; the hydrocarbyl groups having a chain length of from 8 to about 25, preferably 10 to 20, e.g. 14 to 18 carbon atoms.

In the general formula for the ethoxylated non-ionic surfactant, Y is typically:

—O—, —C(O)O—, —C(O)N(R)— or —C(O)N(R)R—

in which R has the meaning given above or can be hydrogen; and Z is at least about 8, preferably at least about 10 or 11.

Preferably the non-ionic surfactant has an HLB of from about 7 to about 20, more preferably from 10 to 18, e.g. 12 to 16.

Examples of non-ionic surfactants follow. In the examples, the integer defines the number of ethoxy (EO) groups in the molecule.

### A. Straight-Chain, Primary Alcohol Alkoxylates

The deca-, undeca-, dodeca-, tetradeca-, and pentadecaethoxylates of n-hexadecanol, and n-octadecanol having an HLB within the range recited herein are useful viscosity/dispersibility modifiers in the context of this invention. Exemplary ethoxylated primary alcohols useful herein as the viscosity/dispersibility modifiers of the compositions are C₁₈ EO(10); and C₁₈ EO(11). The ethoxylates of mixed natural or synthetic alcohols in the “tallow” chain length range are also useful herein. Specific examples of such materials include tallow alcohol-EO(11), tallow alcohol-EO(18), and tallow alcohol-EO (25), coco alcohol-EO(10), coco alcohol-EO(15), coco alcohol-EO(20) and coco alcohol-EO(25).

### B. Straight-Chain, Secondary Alcohol Alkoxylates

The deca-, undeca-, dodeca-, tetradeca-, pentadeca-, octadeca-, and nonadeca-ethoxylates of 3-hexadecanol, 2-octadecanol, 4-eicosanol, and 5-eicosanol having an HLB within the range recited herein are useful viscosity and/or dispersibility modifiers in the context of this invention. Exemplary ethoxylated secondary alcohols useful herein as the viscosity and/or dispersibility modifiers of the compositions are: C₁₆ EO(11); C₂₀ EO(11); and C₁₆ EO(14).

### C. Alkyl Phenol Alkoxylates

As in the case of the alcohol alkoxylates, the hexa- to octadeca-ethoxylates of alkylated phenols, particularly monohydric alkylphenols, having an HLB within the range recited herein are useful as the viscosity and/or dispersibility modifiers of the instant compositions. The hexa- to octadeca-ethoxylates of p-tri-decylphenol, m-pentadecylphenol, and the like, are useful herein. Exemplary ethoxylated alkylphenols useful as the viscosity and/or dispersibility modifiers of the mixtures herein are: p-tridecylphenol EO(11) and p-pentadecylphenol EO(18).

As used herein and as generally recognized in the art, a phenylene group in the non-ionic formula is the equivalent of an alkylene group containing from 2 to 4 carbon atoms.

For present purposes, non-ionics containing a phenylene group are considered to contain an equivalent number of carbon atoms calculated as the sum of the carbon atoms in the alkyl group plus about 3.3 carbon atoms for each phenylene group.

### D. Olefinic Alkoxylates

The alkenyl alcohols, both primary and secondary, and alkenyl phenols corresponding to those disclosed immediately hereinabove can be ethoxylated to an HLB within the range recited herein and used as the viscosity and/or dispersibility modifiers of the instant compositions.

### E. Branched Chain Alkoxylates

Branched chain primary and secondary alcohols which are available from the well-known “OXO” process can be ethoxylated and employed as the viscosity and/or dispersibility modifiers of compositions herein.

### F. Polyol Based Surfactants

Suitable polyol based surfactants include sucrose esters such sucrose monooleates, alkyl polyglucosides such as stearyl monoglucosides and stearyl triglucoside and alkyl polyglycerols.

The above non-ionic surfactants are useful in the present compositions alone or in combination, and the term “non-ionic surfactant” encompasses mixed non-ionic surface active agents.

The non-ionic surfactant may be present in an amount from 0.01 to 10%, more preferably 0.1 to 5%, most preferably 0.35 to 3.5%, e.g. 0.5 to 2% by weight, based on the total weight of the composition.

### Perfume

The compositions of the invention preferably comprise one or more perfumes.

The hydrophobicity of the perfume and oily perfume carrier are measured by C log P. C log P is calculated using the “C log P” program (calculation of hydrophobicities as log P (oil/water)) version 4.01, available from Daylight Chemical Information Systems Inc of Irvine Calif., USA.

It is well known that perfume is provided as a mixture of various components.

It is preferred that at least a quarter (by weight) or more, preferably a half or more of the perfume components have a C log P of 2.0 or more, more preferably 3.0 or more, most preferably 4.5 or more, e.g. 10 or more.

Suitable perfumes having a C log P of 3 or more are disclosed in U.S. Pat. No. 5,500,137.

The perfume is preferably present in an amount from 0.01 to 10% by weight, more preferably 0.05 to 5% by weight, most preferably 0.5 to 4.0% by weight, based on the total weight of the composition.

### Liquid Carrier

The liquid carrier employed in the instant compositions is preferably water due to its low cost, relative availability, safety, and environmental compatibility. The level of water in the liquid carrier is more than about 50%, preferably more than about 80%, more preferably more than about 85%, by weight of the carrier. The level of liquid carrier is greater than about 50%, preferably greater than about 65%, more preferably greater than about 70%. Mixtures of water and a low molecular weight, e.g. <100, organic solvent, e.g. a lower alcohol such as ethanol, propanol, isopropanol or butanol are useful as the carrier liquid. Low molecular weight alcohols including monohydric, dihydric (glycol, etc.) trihydric (glycerol, etc.), and polyhydric (polyols) alcohols are also suitable carriers for use in the compositions of the present invention.

### Co-Active Softeners

Co-active softeners for the cationic surfactant may also be incorporated in an amount from 0.01 to 20% by weight, more preferably 0.05 to 10%, based on the total weight of the composition. Preferred co-active softeners include fatty esters, and fatty N-oxides.

Preferred fatty esters include fatty monoesters, such as glycerol monostearate. If GMS is present, then it is preferred that the level of GMS in the composition, is from 0.01 to 10 wt %, based on the total weight of the composition.

The co-active softener may also comprise an oily sugar derivative. Suitable oily sugar derivatives, their methods of manufacture and their preferred amounts are described in WO-A1-01/46361 on page 5 line 16 to page 11 line 20, the disclosure of which is incorporated herein.

### Polymeric Viscosity Control Agents

The compositions may comprise one or more polymeric viscosity control agents. Suitable polymeric polymeric viscosity control agents include non-ionic and cationic polymers, such as hydrophobically modified cellulose ethers (e.g. Natrosol Plus, ex Hercules), cationically modified starches (e.g. Softgel BDA and Softgel BD, both ex Avebe). A particularly preferred viscosity control agent is a copolymer of methacrylate and cationic acrylamide available under the tradename Flosoft 200 (ex SNF Floerger).

Nonionic and/or cationic polymers are preferably present in an amount of 0.01 to 5 wt %, more preferably 0.02 to 4 wt %, based on the total weight of the composition.

### Further Optional Ingredients

Other optional non-ionic softeners, bactericides, soil-releases agents may also be incorporated in the compositions of the invention.

The compositions may also contain one or more optional ingredients conventionally included in fabric conditioning compositions such as pH buffering agents, perfume carriers, fluorescers, colourants, hydrotropes, antifoaming agents, antiredeposition agents, polyelectrolytes, enzymes, optical brightening agents, anti-shrinking agents, anti-wrinkle agents, anti-spotting agents, antioxidants, sunscreens, anti-corrosion agents, drape imparting agents, anti-static agents, ironing aids and dyes.

### Product Form

In its undiluted state at ambient temperature the product comprises an aqueous liquid.

The compositions are preferably aqueous dispersions of the quaternary ammonium softening material.

### Product Use

The composition is preferably used in the rinse cycle of a home textile laundering operation, where, it may be added directly in an undiluted state to a washing machine, e.g. through a dispenser drawer or, for a top-loading washing machine, directly into the drum. Alternatively, it can be diluted prior to use. The compositions may also be used in a domestic hand-washing laundry operation.

It is also possible, though less desirable, for the compositions of the present invention to be used in industrial laundry operations, e.g. as a finishing agent for softening new clothes prior to sale to consumers.

### Preparation

The compositions of the invention may be prepared according to any suitable method.

In a first preferred method, the quaternary ammonium material, fatty complexing agent, non-ionic stabilising agent and perfume are heated together until a co-melt is formed. Water is then heated and the co-melt is added to water with stirring. The mixture is then allowed to cool. In an alternative method, the perfume can be added to the mixture after the co-melt is formed, e.g. at any time during the cooling stage.

### EXAMPLES

The invention will now be illustrated by the following non-limiting examples. Further modifications will be apparent to the person skilled in the art.

Samples of the invention are represented by a number. Comparative samples are represented by a letter.

All values are % by weight of the active ingredient unless stated otherwise.

### Example A

### Comparative

Tests were conducted using a quaternary ammonium fabric softening agent which was a mixture of hardened tallow esters of triethanolammonium methyl sulphate having a monoester/diester/triester ratio of 20%/60%/20% by weight (Quat). The material also comprised 8 to 10% by weight of esteramine, about 1% by weight of fatty acid and 15% isopropyl alcohol as solvent [N.B. all subsequent raw material examples contain 15% IPA].

Fabric softening compositions were prepared comprising the above Quat and fatty alcohol, with weight ratios of Quat to fatty alcohol of 12:1, 9:1 and 8:1 and with a fixed concentration of 5% by weight Quat (excluding IPA) in water (see Table 1). The composition additionally comprises 0.05% of Natrosol Plus 331 (a hydrophobically modified hydroxyethyl cellulose ex. Hercules).

TABLE 1

| | Sample A1 | Sample A2 | Sample A3 |
|---|---|---|---|
| Quat | 5.88 | 5.88 | 5.88 |
| Fatty Alcohol¹ | 0.41 | 0.55 | 0.62 |
| Perfume | 0.32 | 0.32 | 0.32 |
| Polymer² | 0.05 | 0.05 | 0.05 |
| Minors (dye, | | | |
| preservative, | | | |
| antifoam) | | | |
| Water | to 100% | to 100% | to 100% |

¹Stenol 1618L (ex. Cognis)
²Natrasol Plus 331 (ex Hercules)

The compositions were prepared by adding the molten active Blend (Quat plus Stenol) to hot water 65° C. with stirring. Once all the active is added the mixture is allowed to cool To 40° C. with stirring at which point the perfume is added. The compostion is further cooled to 30° C. at which point the Polymer is added as a 1% solution in water. The resulting Formulations were stored at 45° C. and the viscosity measured Periodically. The results are registered in the following Table 2.

TABLE 2
The figures in the table represent viscosity measurements
(in units of mPa · s) as measured on a Haake RS600 Viscosmeter
at a shear rate of 106 s−1.

| Ex- | | | | | | | |
|---|---|---|---|---|---|---|---|
| am- | Quat:fatty- | | | | | | 12 |
| ple | OH | 0 | 2 weeks | 4 weeks | 6 weeks | 8 weeks | weeks |
| A1 | 12:1 | 116 | 137 | 126 | 100 | 152 | 436 |
| A2 | 9:1 | 155 | — | 120 | 75 | 160 | 600 |
| A3 | 8:1 | 125 | 167 | 135 | 93 | 180 | 470 |

The formulation exhibited a significant increase in thickening after eight weeks. The primary cause of the instability is believed to be the hydrolysis of the ester quaternary which produces insoluble fatty acid.

### Example B & C

### Comparative

Samples were prepared to assess the effect of additional esteramine in the raw material fabric composition. The compositional data of the quaternary raw material used as fabric conditioner in each sample is reported in the following Table 3 and the formulation details are reported in Table 4.

TABLE 3

| Component | Sample B | Sample C |
|---|---|---|
| MEQ/rel. wt % | 17.8 | 17.8 |
| DEQ/rel. wt % | 55.8 | 56.4 |
| TEQ/rel wt % | 26.4 | 25.8 |
| Esteramine/wt % | 7.79 | 14.43 |
| Free fatty acid/wt % | 0.68 | 0.76 |

Whereby MEQ = monoester quat,
DEQ = diester quat and
TEQ = triester quat

TABLE 4

| | Sample B | Sample C |
|---|---|---|
| Quaternary raw | 5.53 | 5.53 |
| material | | |
| Fatty Alcohol¹ | 0.39 | 0.39 |
| Perfume | 0.34 | 0.34 |
| Minors (dye, | | |
| preservative, | | |
| antifoam) | | |
| Water | to 100% | to 100% |

¹Stenol 1618L (ex. Cognis)

The samples were prepared by adding the molten active premix to water at 70° C. with stirring. The hot mixture was then mixed for a further 10 minutes at 70° C. before being cooled to 40° C. at which point perfume was added. After perfume addition, the mixture was cooled to room temperature prior to discharge.

The formulations were stored at 45° C. and the viscosity measured periodically. The results are reported in the following Table 5.

TABLE 5
The figures in the table represent viscosity measurements
(in units of mPa · s) as measured on a Haake RS600 Viscosmeter
at a shear rate of 106 s−1.

| Sample | 0 weeks | 2 weeks | 4 weeks | 6 weeks | 8 weeks |
|---|---|---|---|---|---|
| Example B | 68 | 68 | 85 | 56 | 418 |
| Example C | 53 | 56 | 57 | 300 | 950 |

The results reveal that increasing the esteramine content in the composition provokes faster thickening at elevated temperature.

The formulation composition data for the fabric softener in the samples after 8 weeks storage at 45° C. was measured. The percentage of free fatty acid based on the total weight of quat and fatty acid is reported in the following Table 6.

TABLE 6

| Component | Sample B | Sample C |
|---|---|---|
| MEQ/wt | | |
| DEQ/wt | | |
| TEQ/wt | | |
| Total | | |
| Wt % free fatty acid of | 36.3 | 45.3 |
| total quat and fatty acid | | |

The resultant compositional data confirms that the faster increase in viscosity for Sample C is correlates with a faster rate of hydrolysis for the sample containing the higher level of amine as the wt. % fatty acid in Sample C is significantly higher than it is for Sample B.

### Example D & E

### Comparative

Additional investigations on the effect of amine were conducted by adding extra esteramine during the making of the fabric conditioner formulation. The quaternary active used was the same Quat raw material that was used for Example A.

The formulation details in weight percent are reported in the following Table 7. The compositions were prepared by adding the molten actives (Quat, Fatty Alcohol, Nonionic and ester amine where relevant) to water at 65° C. After the active addition, the resultant mixture was mixed using a high shear mixer and the composition was then cooled 45° C. at which point the perfume was added. The product allowed to cool to 30° C. prior to discharge.

TABLE 7

| Component | Sample D | Sample E |
|---|---|---|
| Quaternary raw | 16.44 | 14.95 |
| material | | |
| Fatty alcohol¹ | 1.1 | 1.1 |
| Nonionic² | 0.42 | 0.42 |
| Additional | 0 | 1.26 |
| esteramine | | |
| Perfume | 0.6 | 0.6 |
| Water | balance | balance |

¹Stenol 1618L (ex. Cognis)
²Genapol C200 (ex Clariant)

The compositional data for the formulations after 12 months at room temperature (RT) storage is reported in the following Table 8.

TABLE 8

| | | MEQ | DEQ | TEQ | |
|---|---|---|---|---|---|
| | | Wt % | Wt % | Wt % | Total |
| | Total wt % | after | after | after | quat Wt % |
| | esteramine in | 12 | 12 | 12 | after 12 |
| | formulation at | months | months | months | months |
| | time zero | at RT | at RT | at RT | at RT |
| Example D | 1.35 | 4.05 | 2.05 | 0.13 | 6.23 |
| Example E | 2.61 | 1.79 | 0.65 | 0.04 | 2.48 |

The data shows the presence of esteramine increases hydrolysis of the Quat.

### Examples F, G & H

### Comparative

Investigations were conducted to determine the effect of the free fatty acid on viscostability. The formulations reported in the following Table 9 were prepared in which all figures are weight percentages. The quaternary active used was the same Quat raw material that was used for Example A. As detailed in example A, the esteramine content in the Quat was in the range 8 to 10% by weight. The process used was the same as that for Examples B and C.

TABLE 9

| Component | Example F | Example G | Example H |
|---|---|---|---|
| Quaternary raw | 5.53 | 5.53 | 5.53 |
| material | | | |
| Fatty alcohol¹ | 0.2 | 0.2 | 0 |
| Fatty acid² | 0 | 0.2 | 0.4 |
| Perfume | 0.34 | 0.34 | 0.34 |
| Water | balance | balance | balance |

¹Stenol 1618L (ex Cognis)
²Pristerine 4916 (ex Uniquema)

The formulations were stored at 45° C. and the viscosity measured periodically. The results are reported in the following Table 10.

TABLE 10
The figures in the table represent viscosity measurements
(in units of mPa · s) as measured on a Haake RS600 Viscosmeter
at a shear rate of 106 s−1.

| | 0 weeks | 2 weeks | 4 weeks | 6 weeks | 8 weeks | 12 weeks |
|---|---|---|---|---|---|---|
| Example F | 17 | 30 | 26 | 19 | 38 | 277 |
| Example G | 70 | 75 | 65 | gelled | — | — |
| Example H | 70 | 40 | 166 | gelled | — | — |

Samples G and H containing free fatty acid gelled after 6 weeks demonstrating the negative impact that fatty acid has on the stability of the product.

### Examples I, J & K

### Comparative

### And Example 1

Investigations were conducted to determine the effect of esterquat distribution on viscostability.

The compositional data for the quaternary raw material of the fabric conditioner is reported in the following Table 11.

TABLE 11

| | Example I | Example J | Example K | Example 1 |
|---|---|---|---|---|
| MEQ/rel. wt % | 18.9 | 17.7 | 17.0 | 15.3 |
| DEQ/rel. wt % | 59.4 | 57.4 | 56.2 | 54.8 |
| TEQ/rel. wt % | 21.7 | 25.0 | 26.8 | 29.8 |
| Esteramine/wt % | 8.51 | 5.76 | 3.10 | 0.27 |
| Free fatty | 0.3 | 0.4 | 0.4 | 0.6 |
| acid/wt % | | | | |

The formulations are detailed in Table 12. The process used to make the samples is the same as in Examples B and C.

TABLE 12

| | Example I | Example J | Example K | Example 1 |
|---|---|---|---|---|
| Quaternary raw | 5.53 | 5.53 | 5.53 | 5.53 |
| material | | | | |
| Fatty Alcohol¹ | 0.39 | 0.39 | 0.39 | 0.39 |
| Perfume | 0.34 | 0.34 | 0.34 | 0.34 |
| Minors (dye, | | | | |
| preservative, | | | | |
| antifoam) | | | | |
| Water | to 100% | to 100% | to 100% | to 100% |

¹Stenol 1618L (ex. Cognis)

The formulations were stored at 45° C. and the viscosity measured periodically. The results are reported in the following Table 13.

TABLE 13
The figures in the table represent viscosity measurements
(in units of mPa · s) as measured on a Haake RS600 Viscosmeter
at a shear rate of 106 s−1.

| | 0 weeks | 2 weeks | 4 weeks | 7 weeks | 8 weeks | 10 weeks |
|---|---|---|---|---|---|---|
| Example I | 56 | 68 | 55 | 95 | 267 | Gelled |
| Example J | 58 | 65 | 59 | 68 | 171 | Gelled |
| Example K | 54 | 64 | 63 | 57 | 126 | 422 |
| Formulation | 45 | 63 | 68 | 57 | 60 | 180 |
| 1 | | | | | | |

The results demonstrate that biasing the esterquat distribution towards TEQ increases visco-stability and reducing esteramine content. Formulation 1 in accordance with the invention demonstrates improved stability.

The compositional data of the formulation after 8 weeks storage at 45° C. is reported in the following Table 14.

TABLE 14

| | Sample I | Sample J | Sample K | Formulation 1 |
|---|---|---|---|---|
| MEQ/wt % | 1.43 | 1.40 | 1.48 | 1.36 |
| DEQ/wt % | 1.00 | 1.02 | 1.25 | 1.46 |
| TEQ/wt % | 0.11 | 0.11 | 0.15 | 0.21 |
| Free fatty | 1.41 | 1.32 | 1.11 | 0.93 |
| acid/wt % | | | | |
| Total quat/wt % | 2.54 | 2.53 | 2.88 | 3.03 |
| Wt % fatty acid | 35.8 | 34.3 | 27.8 | 23.5 |
| of total solids | | | | |

The results demonstrate that biasing the esterquat distribution towards TEQ and reducing esteramine content reduces hydrolysis rates.

### Example 2 and Examples L and M

### Comparative

Additional formulations were prepared as in Examples B and C but with quaternary raw materials having different esterquat distributions. The raw material compositional data used in the formulation is reported in the following Table 15.

TABLE 15

| | Example 2 | Example L | Example M |
|---|---|---|---|
| MEQ/wt % | 10.6 | 13.7 | 17.8 |
| DEQ/wt % | 44.1 | 53.6 | 55.8 |
| TEQ/wt % | 45.3 | 32.7 | 26.4 |
| Esteramine/wt % | 5.34 | 6.49 | 7.18 |
| Free fatty acid/wt % | 0.84 | 0.76 | 0.68 |

The formulations were stored at 45° C. and the viscosity measured periodically. The results are reported in the following Table 16.

TABLE 16
The figures in the table represent viscosity measurements
(in units of mPa · s) as measured on a Haake RS600 Viscosmeter
at a shear rate of 106 s−1.

| | 0 weeks | 2 weeks | 4 weeks | 6 weeks | 8 weeks |
|---|---|---|---|---|---|
| Example 2 | 25 | 34 | 38 | 48 | 105 |
| Example L | 35 | 43 | 50 | 91 | 312 |
| Example M | 68 | 68 | 85 | 56 | 418 |

The results demonstrate that Example 2 in accordance with the invention having a high TEQ and low esteramine exhibits improved viscostability.

The formulation compositional data for the samples after 8 weeks storage at 45° C. is reported in the following Table 17.

TABLE 17

| | Formulation 2 | Sample L | Sample M |
|---|---|---|---|
| MEQ/wt % | 1.79 | 1.63 | 1.86 |
| DEQ/wt % | 1.55 | 0.98 | 1.09 |
| TEQ/wt % | 0.16 | 0.09 | 0.09 |
| Free fatty acid/wt % | 1.57 | 1.59 | 1.73 |
| Total quat/wt % | 3.5 | 2.7 | 3.04 |
| Wt % fatty acid of | 31.0 | 37.1 | 36.3 |
| total solids | | | |

### Examples 3 & 4 and Example N & O

### Comparative

Additional formulations were prepared as in Examples B and C but with quaternary raw materials having different esterquat distributions. The raw material compositional data used in the formulation is reported in the following Table 18.

TABLE 18

| | | | |
|---|---|---|---|
| Example 3 | Example 4 | Example N | Example O |

| | | | | |
|---|---|---|---|---|
| MEQ/wt % | 19.8 | 18.9 | 18.7 | 19.7 |
| DEQ/wt % | 54.7 | 54.3 | 56.4 | 57.8 |
| TEQ/wt % | 25.5 | 26.9 | 24.9 | 22.5 |
| Esteramine/wt % | 0.0 | 0.0 | 0.0 | 0.0 |
| Free fatty | 0.30 | 0.41 | 0.33 | 0.57 |
| acid/wt % | | | | |

The formulations were stored at 45° C. and the viscosity measured periodically. The results are reported in the following Table 19.

TABLE 19
The figures in the table represent viscosity measurements
(in units of mPa · s) as measured on a Haake RS600 Viscosmeter
at a shear rate of 106 s−1.

| | 0 wks | 2 wks | 4 wks | 6 wks | 8 wks | 10 wks | 12 wks |
|---|---|---|---|---|---|---|---|
| Example 3 | 29 | 36 | 30 | 32 | 24 | 54 | 352 |
| Example 4 | 29 | 37 | 35 | 34 | 23 | 64 | 249 |
| Example N | 30 | 32 | 34 | 33 | 21 | 130 | 375 |
| Example O | 77 | 89 | 87 | 68 | 58 | 190 | 503 |

The results demonstrate that Examples 3 and 4 in accordance with the invention having a high TEQ and low esteramine exhibit improved viscostability.

The formulation compositional data for the samples after 8 weeks storage at 45° C. is reported in the following Table 20.

The analytical data supports the fact that the higher TEQ examples of the invention have lower rates of hydrolysis.

TABLE 20

| | Example 3 | Example 4 | Example N | Example O |
|---|---|---|---|---|
| MEQ/wt % | 1.44 | 1.42 | 1.54 | 1.71 |
| DEQ/wt % | 1.92 | 1.92 | 1.93 | 1.87 |
| TEQ/wt % | 0.34 | 0.34 | 0.28 | 0.24 |
| Free fatty | 0.68 | 0.67 | 0.77 | 0.89 |
| acid/wt % | | | | |
| Total quat/wt % | 3.69 | 3.67 | 3.75 | 3.82 |
| Wt % fatty acid of | 15.56 | 15.44 | 17.03 | 18.90 |
| total solids | | | | |

1. A fabric softening composition comprising from 1 to 80% by weight of ester-linked quaternary ammonium fabric softening material comprising a quaternised mixture of mono- di- and tri-ester of alkanolamine in which the tri-ester content of said mixture is from 25 to 50% by weight of said mixture, wherein:
(i) when the tri-ester content is from 25 to 30% by weight of said mixture the free amine content of the composition is less than 0.5% by weight on the weight of said mixture,
(ii) when the tri-ester content is more than 30% by weight of said mixture the free amine content of the composition is less than 6% by weight based on the weight of said mixture,
the composition containing less than 1% by weight of free fatty acid based on said mixture.

2. A composition as claimed in claim 1 wherein the quaternary ammonium cationic softening material is represented by formula (I): 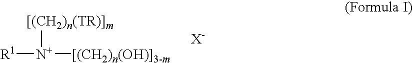
wherein each R is independently selected from a C₅₋₃₅ alkyl or alkenyl group, R¹ represents a C₁₋₄ alkyl or hydroxyalkyl group or a C₂₋₄ alkenyl group, 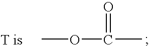
n is an integer selected from 1 to 4, m is 1, 2 or 3 and denotes the number of moieties to which it refers that pend directly from the N atom, and X⁻ is an anionic substance selected from the group consisting of halides or alkyl sulphates.

3. A composition as claimed in claim 1 in which the fabric softening material is a mixture of tallow esters of triethanolamine ammonium compound.

4. A composition as claimed in claim 3 in which the tallow is hardened tallow.

5. A composition as claimed in claim 1 in which the tri-ester content is more than 30% and the free amine content is less than 5% by weight of the mixture.

6. A composition as claimed in claim 1 which comprises from 0.2 to 15% by weight of a fatty alcohol containing from 8 to 22 carbon atoms.

7. A composition as claimed in claim 1 which comprises from 0.01 to 18% by weight of a non-ionic surfactant.
